(19) United States
(12) Patent Application Publication
(10) Pub. No.: US 2004/0236685 A1
(43) Pub. Date: Nov. 25, 2004

(54) Devices and methods for charging for an electronic pre-paid car with positional determination (gps pre-paid card) for a dual gps based toll system

(76) Inventor: Janos Gila, Modling (AT)

Correspondence Address: HARNESS, DICKEY & PIERCE, P.L.C., P.O.BOX 8910, RESTON, VA, 20195, US

(21) Appl. No.: 10/480,436

(22) PCT Filed: Jun. 12, 2002
(86) PCT No.: PCT/DE02/02157

(30) Foreign Application Priority Data
Jun. 12, 2001 (AT) 912/2001

(51) Int. Cl. G06F 17/60

(52) U.S. Cl. 705/40

(57) ABSTRACT

A methods and a system for electronic charging by means of a positional determination system (PSE) for determining the current local co-ordinates (OKO) for a vehicle (FAR), whereby at least one determinable user authorisation (BER) is activated and is transmitted to a reckoning unit (BEE) on board the vehicle (FAR), for determining toll charges.

This application is the national phase under 35 U.S.C. § 371 of PCT International Application No. PCT/DE02/02157 which has an International filing date of Jun. 12, 2002, which designated the United States of America and which claims priority on Austrian Patent Application number AT 912/2001 filed Jun. 12, 2001, the entire contents of which are hereby incorporated herein by reference.

### FIELD OF THE INVENTION

The invention generally relates to a method for electronic toll payment. Preferably, it relates to a method for payment using a position finding system to determine the current location coordinates of a vehicle.

The invention also generally relates to a system for electronic toll payment; preferably using a position finding system to determine the current location coordinates of a vehicle.

### BACKGROUND OF THE INVENTION

A system and a method have been disclosed in DE 43 44 433 A1. In the known method, current location coordinates are recorded by a GPS receiver, are compared with the entry/exit coordinates which are stored internally in an electronic vignette for a turnpike route. Further, if the coordinates match, they are transmitted via a digital mobile network to a billing center which is external to a vehicle, along with the turnpike kilometers traveled as well as the turnpike fees associated with them, calculated from the transmitted data in the billing center.

This method has the particular disadvantage that only entry and exit points which are permanently present in the vignette for a route which is subject to a toll can be recorded. On the basis of the billing type, which is linked to specific locations (toll stations), the billing for the toll fees is greatly restricted. Thus, for example, it is impossible to carry out billing on the basis of the distance traveled on routes which are subject to a toll. A further disadvantage of the known method is that no toll fees can be billed if the communication link between the vehicle and the billing center fails.

### SUMMARY OF THE INVENTION

One object of an embodiment of the invention is to provide a way which can be implemented easily and is cost effective for recording and payment of toll fees. Furthermore, it may allow simple matching to different billing types for fees for routes which are subject to a toll, and/or payment of the toll fees independently of any communication link between the vehicle and a billing center which is external to the vehicle.

According to an embodiment of the invention, an object may be achieved by a method wherein at least one usage authorization, which can be predetermined, is transmitted to a calculation unit located on board the vehicle, for determination of toll fees. It further may be activated, and on the basis of this, a check may be carried out to determine whether the vehicle is authorized to use a route over which the vehicle is being driven.

The solution according to an embodiment of the invention, allows a wide degree of freedom for the billing of toll fees on the basis of types of usage authorization which can be predetermined (time cards, credits, route credits, etc.).

One possible embodiment of the usage authorization includes the usage authorization being a time card which authorizes the use of at least one route which is subject to a toll, in a time period which can be predetermined.

Another advantageous variant provides for the usage authorization to be in the form of a chargeable credit.

A further variant of an embodiment of the invention provides for the usage authorization to be linked to an amount, which can be predetermined, for a distance which has been traveled on routes which are subject to a toll. The usage authorization may advantageously be transmitted in the form of a code.

Further advantages can be achieved by the usage authorization being transmitted to the calculation unit using an input apparatus which is provided specifically for this purpose.

One variant for transmission of the usage authorization provides for the usage authorization to be stored in a mobile data storage medium, for example a magnetic strip card or a smart card. Further, the input apparatus may be a suitable reader, for example a magnetic strip card reader or a smart card reader, with the usage authorization being read by the reader and being transmitted to the calculation unit.

In another advantageous variant of an embodiment of the invention, the calculation unit may be linked to a data network, with the usage authorization being transmitted to the calculation unit via this data network. This data network is preferably the Internet.

A further variant for transmission of the usage authorization is for the calculation unit to be linked to a radio network, and for the code to be transmitted to the calculation unit via the radio network, with this radio network preferably being the GSM network.

Further advantages can be achieved by the usage authorization being entered manually in the calculation unit.

A system which is particularly suitable for carrying out the method according to an embodiment of the invention is one which is designed to transmit at least one usage authorization, which can be predetermined, to a calculation unit which is located on board the vehicle in order to determine toll fees, and to activate it.

In a first advantageous variant of the system according to an embodiment of the invention, the usage authorization may be a time card which authorizes the use of at least one route, which is subject to a toll, in a time period which can be predetermined.

In a second advantageous variant of an embodiment of the invention, the usage authorization may be a chargeable credit.

In a further variant of an embodiment of the invention which is likewise highly advantageous, the usage authorization may be linked to an amount, which can be predetermined, for a distance which has been traveled on routes which are subject to a toll.

In one preferred embodiment of the invention, the system is designed to transmit the usage authorization in the form of a code to the calculation unit.

Furthermore, the calculation unit can be linked to a data network and the system may be designed to transmit the usage authorization to the calculation unit via this data network, with this data network preferably being the Internet.

The calculation unit may also be linked to a radio network, and the system may be designed to transmit the usage authorization to the calculation unit via the radio network, with this radio network preferably being the GSM network.

Furthermore, the calculation unit may be designed for the usage authorization to be entered manually.

### BRIEF DESCRIPTION OF THE DRAWINGS

The invention together with further advantages will be explained in more detail with the following text with reference to a number of exemplary embodiments, although these are not restrictive, which are illustrated in the drawing in which, illustrated schematically:

FIG. 1 shows a system for recording a payment of toll fees having a toll payment apparatus, which is arranged on board the vehicle, in order to determine the toll fees;

FIG. 1a shows the toll payment apparatus from FIG. 1 in more detail;

FIG. 2 shows the toll payment apparatus from FIG. 1 in more detail and a reader for billing for user authorization to the calculation unit.

FIG. 3 shows a mobile data storage medium with a code for billing for a user authorization to the calculation unit, and

FIG. 4 shows the calculation unit from FIG. 1, which is linked to a data network for the purpose of charging a usage authorization.

### DETAILED DESCRIPTION OF THE PREFERRED EMBODIMENTS

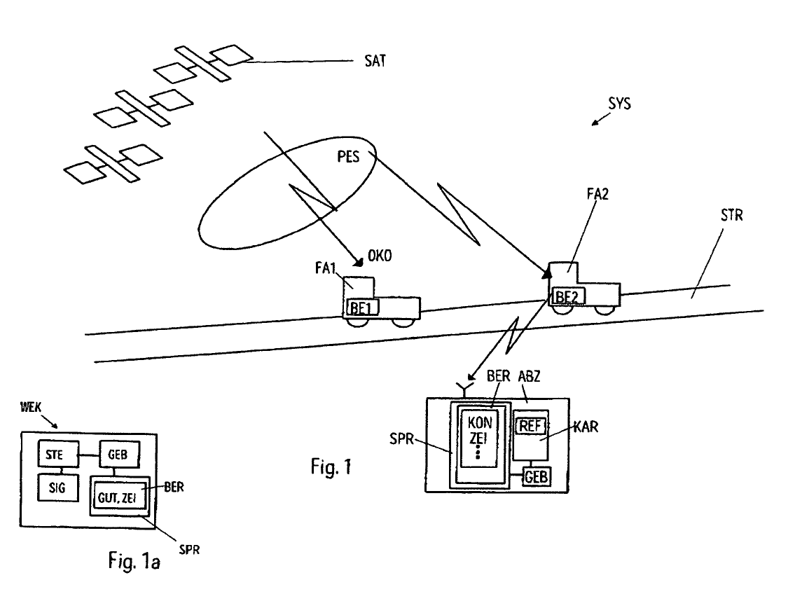

As is shown in FIG. 1, a system SYS for electronic toll payment has a position detection system, for example the known “Global Positioning System”, or GPS system for short, for location of a vehicle FAR.

On the basis of location coordinates OKO which are determined from the position data, the toll payment apparatus BEV can check whether the route on which the vehicle FAR is traveling is subject to a toll—for example by calculation of a signature SIG which is characteristic for that route and comparison of the signature SIG with reference signatures REF for routes which are subject to a toll. If there is a good match between the signature SIG and the reference signature, the route which is being traveled on may be regarded as being subject to a toll, with the toll fee GEB to be paid being a toll fee which is associated with the reference signature REF that produces the match. Furthermore, the toll payment apparatus BEV may be designed to calculate the kilometers traveled on the route which is subject to a toll.

The usage authorization BER may, for example, be in the form of a credit GUT and may be transmitted to the toll payment apparatus BEV and/or stored in a memory SPR. In this case, the controller STE may be designed to calculate toll fees GEB which are incurred, and to debit them from the credit GUT. If the credit GUT has been consumed, and there is no further usage authorization BER, then the vehicle FAR must no longer use the routes STR which are subject to tolls.

The usage authorization BER need not necessarily be a credit GUT. For example, the usage authorization BER may also be in the form of a time card ZEI which is stored in the memory SPR of the toll payment apparatus BEV and authorizes the use of routes STR which are subject to a toll and can be predetermined, in a specific time period, etc. (FIG. 1a).

Different types of usage authorization BER may also be activated or enabled simultaneously in the toll payment apparatus BEV, and may be used as required. For example, if the usage authorization BER for one route is in the form of a time card ZEI which authorizes use of the route STR which is subject to a toll in a specific time period, then a credit GUT can also be provided in parallel with this.

If the usage authorization BER includes a number of kilometers, which can be predetermined, that may be traveled on routes STR which are subject to a toll, then the number of kilometers which have already been traveled can be debited from a route credit which is stored in the memory unit SPR for the toll payment apparatus BEV.

Usage authorization BER for restricted times may, for example, be implemented by attaching a time stamp STE to the signature SIG. The signature SIG and the time stamp STE can then be used jointly to uniquely define the route which has been used and has been subject to a toll as well as the usage time, with a check as to whether the vehicle FAR may or may not drive on the route that is defined by the signature SIG at this time and can be carried out on the basis of the time stamp STE.

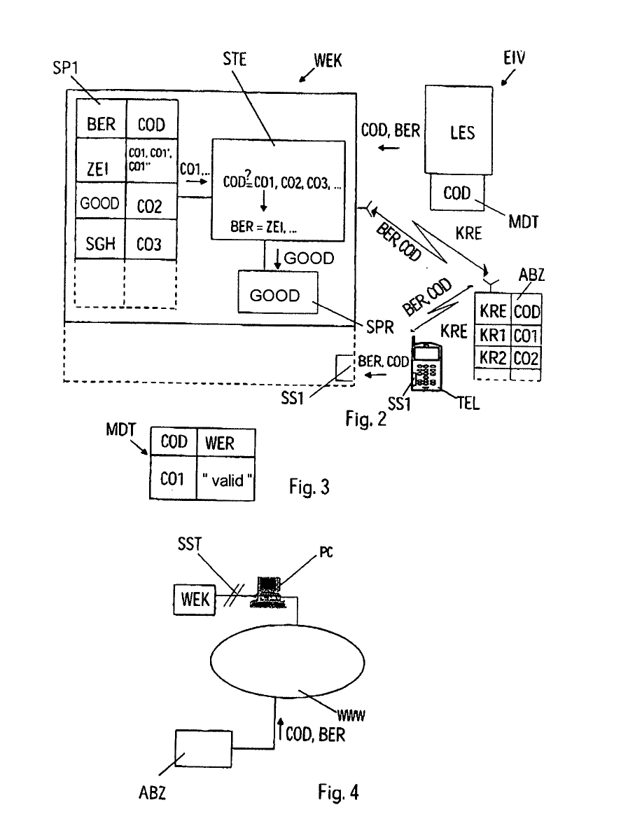

The type of usage authorization BER (credit, time card, route credit, timing, etc.) which is desired by a vehicle keeper may, for example, be transmitted as a code COD to the toll payment apparatus BEV. Each type of usage authorization BER may in this case be assigned a code CO1, CO2, CO3, which can be predetermined, in a memory unit SP1 for the toll payment apparatus BEV (FIG. 2). For example, a first code CO1 may be associated with a time card ZEI for all routes STR which are subject to a toll within a region which can be predetermined, while another code CO2 may charge a credit GUT by an amount which can be predetermined, or a third code CO3 increases a route credit SGH by an amount which can be predetermined, etc.

After receiving the code COD, the controller STE for the toll payment apparatus BEV can identify and enable or activate the appropriate usage authorization BER by comparison of the code COD which has been obtained by the user with the codes CO1, CO2, CO3 which are stored in the memory unit SP1.

If a time card ZEI for a specific route and a credit GUT are activated in the toll payment apparatus BEV, then the driver can deactivate the debiting via the credit GUT and can electronically “produce” the time card ZEI as soon as he enters the route for which the time card exists. This production of the time card ZEI corresponds essentially to the change in the billing mode in the toll payment apparatus BEV, and can be carried out by operation of an input unit for the toll payment apparatus BEV for example a key. In principle, any combination of user authorization BER is possible.

A user authorization BER in the form of a credit GUT may be associated with a number of codes CO1, CO1′, CO1″ which correspond to different amounts of money. Once the appropriate amount has been paid, the code CO1, CO1′, CO1″ which corresponds to this amount can be transferred to the toll payment apparatus BEV, and the credit GUT can be increased by this amount.

The other forms of usage authorization BER may also be obtained in an analogous manner to what has been stated above. That is to say the “enable” code for this form of usage authorization BER is obtained against payment of the amount associated with the usage authorization BER to the toll operator by the vehicle user. This code is transmitted to the toll payment apparatus BEV.

By way of example, the code COD may be transmitted via an input apparatus EIV which is linked to the toll payment apparatus BEV with or without the use of cables. Examples of a cable-based link between the input apparatus BIV and the toll payment apparatus BEV would be copper wire, glass fiber, etc. Examples for a link which does not make use of cables include radio, infrared transmission, laser etc.

In order to prevent a usage authorization BER from being loaded into the toll payment apparatus BEV as a form of misuse, the code CO1, CO2, CO3 may be scrambled. It may be transmitted to the toll payment apparatus BEV in a form which cannot be identified by the user.

For example, the code COD may be stored in a mobile data storage medium. In this case, the input apparatus EIV is designed as a reader LES for mobile data storage media in order to transmit the user authorization BER or the code COD to the calculation unit. In order to prevent the mobile data storage medium from being reused as a form of misuse, the reader LES may be designed to end the transmission process of the code COD to the toll payment apparatus BEV with a cancellation of the mobile data storage medium. This cancellation may, for example, include the information which is contained in the mobile data storage medium being erased by the reader, or a value WER which indicates the validity of the mobile data storage medium being set from “valid” to “invalid” (FIG. 3).

Another possible way to transmit the code COD to the toll payment apparatus BEV is for it to be entered manually in the toll payment apparatus BEV after payment of the amount associated with it by someone who is authorized by the toll operator, via an input apparatus for the toll payment apparatus BEV, for example a keyboard or a touch screen.

Furthermore, the code COD may also be transmitted via a radio network, preferably the GSM network, to the toll payment apparatus BEV. For this purpose, the toll payment apparatus BEV may have a radio module, for example a GSM module, via which a link can be set up to the billing center ABZ of the toll station operator on demand, for example by activation of a key or key combination, which can be predetermined, on a keyboard for the toll payment apparatus BEV. Once a link has been set up, the vehicle user can select the desired user authorization BEV, for example assisted by an audible menu, as is normally used, for example, for prepayment cards for mobile radios. The usage authorization BER or the code COD may be paid for, for example, by a credit card or by a debit mandate in favor of the toll operator for an account of the vehicle user.

After selection of the desired usage authorization BER and payment for it, the code COD may be transmitted from the billing center ABZ to the toll payment apparatus BEV.

As is known from GSM prepayment card mobile radio telephones, the user authorization BER may be paid for by obtaining a prepayment card, on which at least one credit code KRE, KR1, KR2 is printed which is associated with the respective type of user authorization BER. After setting up a link to the billing center ABZ via the GSM network, this credit code KRE, KR1, KR2 can be transmitted from the toll payment apparatus BEV to the billing center ABZ after entering it in the toll payment apparatus BEV, for example via a keyboard for the calculation unit BEE. After receiving the credit code KRE, the billing center ABZ transmits the usage authorization BER which is associated with this credit code KRE, KR1, KR2, for example in the form of a code COD, as already described.

The setting up of a connection for transmission of the credit code KRE, KR1, KR2 and of the user authorization BER may also take place between the input apparatus EIV and the billing center ABZ. The input apparatus EIV may, for example, be a mobile radio telephone TEL via which the credit code KRE, KR1, KR2 is transmitted to the billing center ABZ, with the corresponding user authorization BER being transmitted in the form of the code COD from the billing center ABZ to the mobile radio telephone after obtaining the credit code KRE, KR1, KR2. The user authorization BER can then be transmitted on request from the mobile radio telephone TEL to the toll payment apparatus BEV via an interface SS1, for example an infrared interface.

As is shown in FIG. 4, the usage authorization BER and/or the code CO1, CO2, CO3 may however, also be transmitted to the toll payment apparatus BEV via a computer PC which is connected to a data network WWW, preferably the Internet. In this case, the code CO1, CO2, CO3 may be transmitted on request from a billing center ABZ of the toll station operator via the Internet to the computer PC, which is designed to transmit the code CO1, CO2, CO3 to the toll payment apparatus BEV, for example via a USB interface. The usage authorization BER may be paid for, in the same way as when the code COD is transmitted, via a radio network, by credit card etc.

Exemplary embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A method for electronic toll payment using a position finding system for determination of a current location coordinate of a vehicle, wherein at least one usage authorizations is associated with a vehicle keeper;
transmitting at least one usage authorization to a calculation, unit located on the vehicle, for determination of toll fees, wherein the calculation unit is activated based on the at least one usage authorization; and
determining whether the vehicle is authorized to use a route over which the vehicle is being driven.

2. The method as claimed in claim 1, wherein the at least one usage authorization includes a time card which authorizes the use of at least one route subject to a toll, in a determinable time period.

3. The method as claimed in claim 1, wherein the at least one usage authorization includes a chargeable credit.

4. The method as claimed in claim 1, wherein the at least one usage authorization is linked to a determinable amount for a distance which has been traveled on routes subject to a toll.

5. The method as claimed in claim 1, wherein the at least one usage authorization is transmitted in the form of a code.

6. The method as claimed in claim 1, wherein the at least one usage authorization is transmitted to the calculation unit via a provided input apparatus.

7. The method as claimed in claim 6, wherein the at least one usage authorization is stored in a mobile data storage medium, and wherein the input apparatus is a reader for the mobile data storage medium, and wherein the at least one usage authorization is read by that reader and is transmitted to the calculation unit.

8. The method as claimed in claim 1, wherein the calculation unit is linked to a data network, and the at least one usage authorization is transmitted to the calculation unit via this data network.

9. The method as claimed in claim 8, wherein the data network is the Internet.

10. The method as claimed in claim 1, wherein the calculation unit is linked to a radio network, and the at least one usage authorization is transmitted to the calculation unit via the radio network.

11. The method as claimed in claim 10, wherein the radio network is the GSM network.

12. The method as claimed in claim 1, wherein the code is entered manually.

13. A system for electronic toll payment, comprising:
a position finding system for determination of the current location coordinates of a vehicle, wherein at least one usage authorization is associated with a vehicle keeper; and
a device, adapted to transmit at least one usage authorization to activate a calculation unit located on the vehicle to determine toll fee.

14. The system as claimed in claim 13, wherein the at least one usage authorization includes a time card which authorizes the use of at least one route, which is subject to a toll, in a determinable time period.

15. The system as claimed in claim 13, wherein the at least one usage authorization includes a chargeable credit.

16. The system as claimed in claim 13, wherein the at least one usage authorization is linked to a determinable amount for a distance traveled on routes subject to a toll.

17. The system as claimed in claim 13, wherein the system is designed to transmit the at least one usage authorization in the form of a code to the calculation unit.

18. The system as claimed in claim 13, wherein an input apparatus, linked to the calculation unit, is adapted to transmit the at least one usage authorization to the calculation unit.

19. The system as claimed in claim 18, wherein the at least one usage authorization is stored in a mobile data storage medium, and wherein the input apparatus includes a reader for the mobile data storage medium, wherein the reader is designed to read out the code and transmit the code to the calculation unit.

20. The system as claimed in claim 13, wherein the calculation unit is linked to a data network, and the system is designed to transmit the at least one usage authorization to the calculation unit via this data network.

21. The system as claimed in claim 20, whrein the data network is the Internet.

22. The system as claimed in claim 13, wherein the calculation unit is linked to a radio network, and the system is designed to transmit the at least one usage authorization to the calculation unit via the radio network.

23. The system as claimed in claim 22, wherein the radio network is the GSM network.

24. The system as claimed in claim 13, wherein the calculation unit is designed for the at least one usage authorization to be entered manually.

25. The method as claimed in claim 2, wherein the at least one usage authorization includes a chargeable credit.

26. The method as claimed in claim 2, wherein the at least one usage authorization is linked to a determinable amount for a distance which has been traveled on routes subject to a toll.

27. The method as claimed in claim 2, wherein the at least one usage authorization is transmitted in the form of a code.

28. The method as claimed in claim 3, wherein the at least one usage authorization is linked to a determinable amount for a distance which has been traveled on routes subject to a toll.

29. The method as claimed in claim 3, wherein the at least one usage authorization is transmitted in the form of a code.

30. The system as claimed in claim 14, wherein the at least one usage authorization includes a chargeable credit.

31. The system as claimed in claim 14, wherein the at least one usage authorization is linked to a determinable amount for a distance traveled on routes subject to a toll.

32. The system as claimed in claim 29, wherein the at least one usage authorization is linked to a determinable amount for a distance traveled on routes subject to a toll.

33. The system as claimed in claim 14, further comprising:
an input apparatus, linked to the calculation unit, adapted to transmit the usage authorization to the calculation unit.

34. The system as claimed in claim 15, further comprising:
an input apparatus, linked to the calculation unit, adapted to transmit the usage authorization to the calculation unit.

35. The system as claimed in claim 16, further comprising:
an input apparatus, linked to the calculation unit, adapted to transmit the usage authorization to the calculation unit.

36. A system for electronic toll payment, comprising:
means for determining a current location coordinates of a vehicle, wherein at least one usage authorization is associated with a vehicle keeper; and
means for transmitting at least one usage authorization to activate a calculation unit located on the vehicle to determine toll fees.

37. The system as claimed in claim 36, wherein the at least one usage authorization includes a time card which authorizes the use of at least one route, which is subject to a toll, in a determinable time period.

38. The system as claimed in claim 36, wherein the at least one usage authorization includes a chargeable credit.

39. The system as claimed in claim 36, wherein the at least one usage authorization is linked to a determinable amount for a distance traveled on routes subject to a toll.

40. The system as claimed in claim 36, wherein the system is designed to transmit the at least one usage authorization in the form of a code to the calculation unit.

41. The system as claimed in claim 13, wherein an input device, linked to the calculation unit, is for transmitting the at least one usage authorization to the calculation unit.

42. The system as claimed in claim 41, wherein the at least one usage authorization is stored in a mobile data storage medium, and wherein the input device includes a reader for the mobile data storage medium, wherein the reader is designed to read out the code and transmit the code to the calculation unit.
